(19) United States
(12) Patent Application Publication
(10) Pub. No.: US 2005/0089187 A1
(43) Pub. Date: Apr. 28, 2005

(54) Nanoporous diaphragm for electromagentic transducer

(76) Inventors: Patrick M. Turnmire, Tempe, AZ (US); Enrique M. Stiles, Imperial Beach, CA (US); Richard C. Calderwood, Portland, OR (US)

Correspondence Address: RICHARD C. CALDERWOOD, 2775 NW 126TH AVE, PORTLAND, OR, 97229-8381, US

(21) Appl. No.: 10/693,108

(22) Filed: Oct. 24, 2003

(51) Int. Cl. H04R 1/00; H04R 9/06; H04R 11/02

(52) U.S. Cl. 381/396; 381/398; 381/412

(57) ABSTRACT

An electromagnetic transducer such as a tweeter audio speaker, having a very low density diaphragm constructed of a nanoporous material such as aerogel or the like. The solid aerogel diaphragm has improved rigidity and reduced susceptibility to breakup modes. The aerogel may be provided with a skin of e.g. metal, plastic, or oxide to protect it, and it may be built by filling a conventional cone. The skin may encapsulate part or all of the aerogel body's surface, and it may further encapsulate the bobbin, or even the entire voice coil assembly. The nanoporous material comprises a very large percentage of the diaphragm's overall volume, giving the diaphragm a very low overall mass density with respect to conventional diaphragms. This allows diaphragm configurations, such as solid filled spheres, which have excellent stiffness without suffering from the large mass that such shapes would mandate if constructed from conventional materials.

### BACKGROUND OF THE INVENTION

1. Technical Field of the Invention

This invention relates generally to electromagnetic transducers such as audio speakers, and more specifically to an improved diaphragm having a very low density, such as one formed from a nanoporous material such as aerogel.

2. Background Art

FIG. 1 illustrates a conventional audio speaker 10 such as is known in the prior art, shown as symmetrical about a center line CL. The speaker includes a motor structure 11 including a magnetic air gap. The motor structure is coupled to a diaphragm assembly 12 by a frame 13. The diaphragm assembly includes a diaphragm 14 which is coupled to the frame by a first suspension component 15 known as a surround. A bobbin or voice coil former 16 is coupled to the diaphragm. An electrically conductive voice coil 17 is coupled to the bobbin and is disposed within the magnetic air gap. The bobbin is coupled to the frame by a second suspension component 18 known as a spider. A dust cap 19 seals the diaphragm assembly and protects against infiltration of dust particles and other stray materials which might interfere with the operation or quality of the speaker.

The cone is typically very thin, on the order of 1 mm thick. Conventional cones are made of paper, plastic, metal, or other such materials. It is desirable to minimize the mass of the diaphragm, to reduce the workload on the motor and improve the frequency response, efficiency, and acoustic accuracy of the speaker. It is also desirable to maximize the stiffness of the diaphragm, to avoid deformations under acceleration, which would produce acoustic distortion. These two goals are somewhat conflicting, in that the stiffness of the diaphragm can be increased by using thicker paper etc., which increases the diaphragm's mass.

Audax, a division of Harman International, offers a product line known as “High Definition Aerogel (HDA) cones”. The HDA cones are only available in woofers and mid-bass woofers, and are only available as cone-shaped diaphragms for woofers and midrange speakers, not as domes for tweeters. Audax received U.S. Pat. No. 5,380,960 on a process for manufacturing the an aerogel material for speaker cones; this could possibly be the process by which the HDA cones are manufactured. One exemplary Audax HDA speaker is the HM100Z2 “4-inch Aerogel cone mid/bass” driver. Its cone appears to be a conventional paper cone which has had a shiny outer surface applied. The aerogel component, if any, might be this shiny skin; or, it might be that aerogel has been intermixed with the paper fibers, either of which would appear to be covered by the '960 patent. Regardless, the paper fibers comprise the vast majority of the volume and the structural material of the “aerogel cone”, which has a thickness of only a few thousandths of an inch, not discernibly different than any other conventional paper or plastic cone. The overall density of the “aerogel cone” does not appear to be materially different than that of a conventional paper cone. That being the case, in order to e.g. double the stiffness of the Audax aerogel cone, it would be necessary to double the amount of the paper fiber or paper fiber/aerogel mixture. This would double the mass of the cone.

FIG. 2 illustrates a speaker 20 having a solid or filled diaphragm 21, such as some models of the KEF B139 which were available from KEF (England) in the 1960's. The diaphragm is either a solid block of polystyrene foam, or it is a polypropylene cone which has been filled with a monolithic block of polystyrene foam. Polystyrene foam has a density of 0.01 gm/cm³. Alloy skinned polystyrene foam has an overall density of 0.027 gm/cm³. Polystyrene foam is the lightest material which has, to date, been used as a significant portion of a speaker diaphragm's volume or structural integrity.

FIG. 3 illustrates a speaker 30 having a diaphragm 31 whose volume has been increased—or, put another way, whose density has been decreased—by the addition of a filler material into the plastic of the cone. Filler materials which have been used include talc, carbon black, and diatomaceous earth, typically as 10% of the total volume of the diaphragm material. This has only a moderate impact on the density, because of the low percentage of filler material and the relatively high density of the filler material itself.

FIG. 4 illustrates a conventional dome tweeter audio speaker 40. The tweeter includes a dome diaphragm 41, which is traditionally formed from a thin sheet of fabric, metal, or plastic. A surround 24 couples the dome assembly to the cup of the motor structure.

Due to their high operating frequencies, tweeters are commonly self-contained, meaning that they enclose a volume 42 of captive air between the dome and the motor structure, which is not vented. In order to reduce acoustic wave reflections from the hard top plate of the motor structure, a quantity of acoustic damping material 43 is commonly affixed to the top plate, often in a domed button shape somewhat smaller than the inside surface of the dome. The button needs to be removed far enough from the dome, that the dome does not strike the button during operation, lest the sound become distorted.

FIG. 5 illustrates an alternative embodiment of a tweeter dome 50 such as is sometimes employed in the prior art. The dome consists of a very thin layer of flexible fabric. A center portion of the fabric is formed into a dome 51, and a perimeter portion of the fabric is formed into a surround 52 which is integral with the dome. The dome is commonly made rigid by adding a stiffening material such as epoxy to its portion of the fabric, while the surround is not stiffened, or is less stiffened than the dome. Similarly shaped domes are also formed of plastic. The thin dome has a hollow, concave underside.

FIG. 6 illustrates a different tweeter dome 60 such as is sometimes employed in the prior art. The dome has a laminated structure, including an exterior layer 61 and an interior layer 62, and perhaps other, intermediate layers (not shown). The thin, laminated dome has a hollow, concave underside.

FIG. 7 illustrates a conventional tweeter 40 exhibiting breakup modes of its dome 41 during operation of the tweeter. As the alternating current electrical signal causes acceleration of the voice coil, such as in the extension (outbound) direction as illustrated, some portions of the tweeter dome react more quickly to the acceleration than do other portions. In the example, shown, the voice coil and bobbin are accelerating the dome upward, or extending the dome, and the outer portions 71 of the dome are reacting in time with the bobbin, but the middle portion 72 of the dome is unable to react as quickly, and collapses inward. The central portion may actually be moving outward, just at a slower rate than the outer portions of the dome, or, in extreme cases, it may still be moving inward from the previous half cycle of operation. In more complex cases, typically occurring at very high frequencies and high operating powers, the dome may exhibit far more complex breakup modes, not limited to two portions as shown.

Much effort has been spent in the prior art, attempting to make tweeter domes more rigid, to alleviate these breakup modes. These solutions, such as the laminated dome structure, do offer some measure of increased rigidity of the diaphragm, but at the expense of significantly increased mass of the diaphragm. The more massive the diaphragm (and other moving parts), the less efficient the transducer will be, and the more power (magnetic and/or electrical) it will require to effect an adequate acceleration of the diaphragm.

What is needed is an improved diaphragm which has a significantly decreased overall density, such that its stiffness can be improved without increasing its mass, with respect to a conventional diaphragm.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows, in cross-section, speaker having a conventional thin cone diaphragm according to the prior art.

FIG. 2 shows, in cross-section, a speaker having a solid filled diaphragm according to the prior art.

FIG. 3 shows, in cross-section, a speaker having a plastic-and-filler cone according to the prior art.

FIG. 4 shows, in cross-section, a tweeter having a dome diaphragm according to the prior art.

FIG. 5 shows, in cross-section, an integrally formed tweeter dome and surround, according to the prior art.

FIG. 6 shows, in cross-section, a laminated tweeter dome, according to the prior art.

FIG. 7 shows, in cross-section, a prior art tweeter dome suffering breakup modes during operation.

FIGS. 8-11 show, in cross-section, tweeters having domes according to several embodiments of this invention.

FIGS. 12-18 show, in cross-section, details of different embodiments of tweeter domes according to this invention.

FIG. 19 shows, in cross-section, a speaker having a filled cone according to another embodiment of this invention.

FIG. 20 shows, in cross-section, a tweeter having a spherical dome according to one embodiment of this invention.

FIG. 21 shows, in cross-section, a compression driver type electromagnetic transducer having an inverted dome according to another embodiment of this invention.

FIG. 22 shows, in cross-section, a sandwiched cone embodiment of the invention.

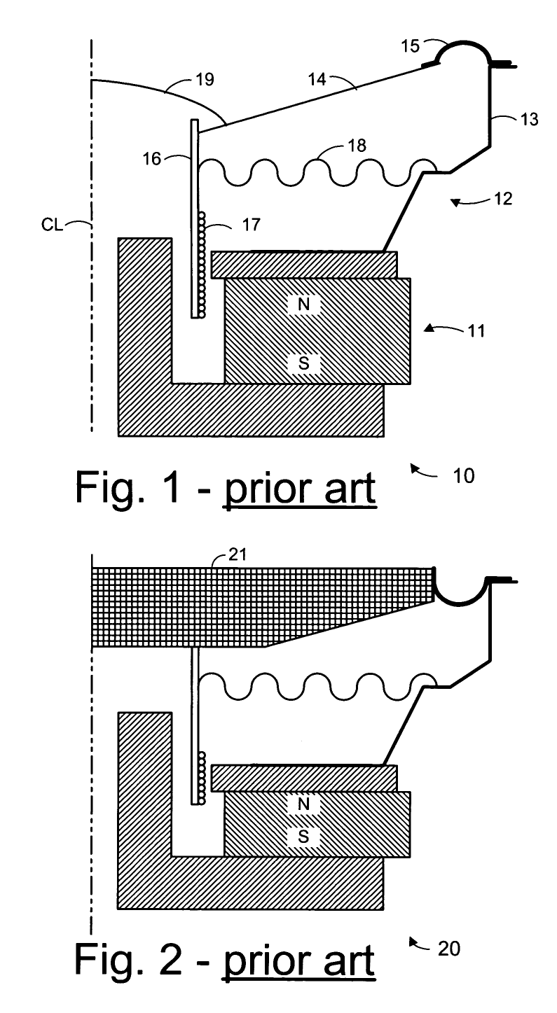

### DETAILED DESCRIPTION

The invention may be utilized in a variety of magnetic transducer applications, including but not limited to audio speakers, microphones, mechanical position sensors, actuators, and the like. For the sake of convenience, the invention will be described with reference to audio speaker embodiments, but this should be considered illustrative and not limiting.

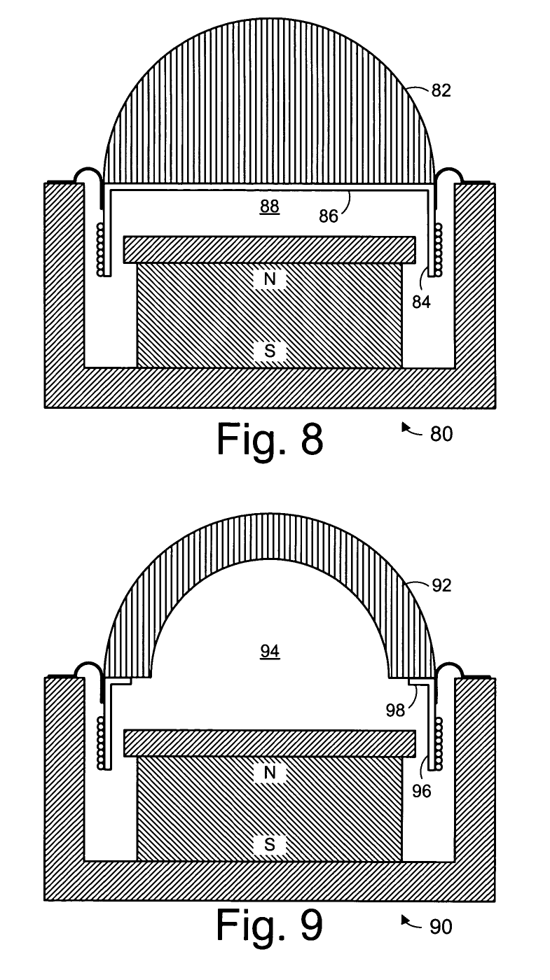

FIG. 8 illustrates one embodiment of a tweeter 80 which utilizes a dome 82 according to one embodiment of this invention. The dome is constructed of an ultra lightweight, solid, nanoporous material, such as an aerogel, nanocomposites, or the like, hereinafter collectively referred to as aerogel for convenience. The aerogel dome is coupled to a bobbin 84 which, in some embodiments, may have a closed outer end 86 forming a plate or base to which the aerogel dome is coupled such as with glue. A volume 88 of air is enclosed within the tweeter to provide acoustic loading. The dome may in some embodiments be a hemisphere, as shown.

FIG. 9 illustrates another tweeter 90 utilizing a different embodiment of an aerogel dome 92. The bottom or underside of the dome is not flat, but is arched or concave to increase the volume 94 of air enclosed within the tweeter. The inner or bottom surface and the outer or exterior surface of the aerogel dome may be of similar concentric circle shapes, as shown. The bobbin 96 does not have a closed outer end. In some embodiments, the bobbin may include a truncated outer end which is partly closed to provide a platform 98 to which the dome is coupled.

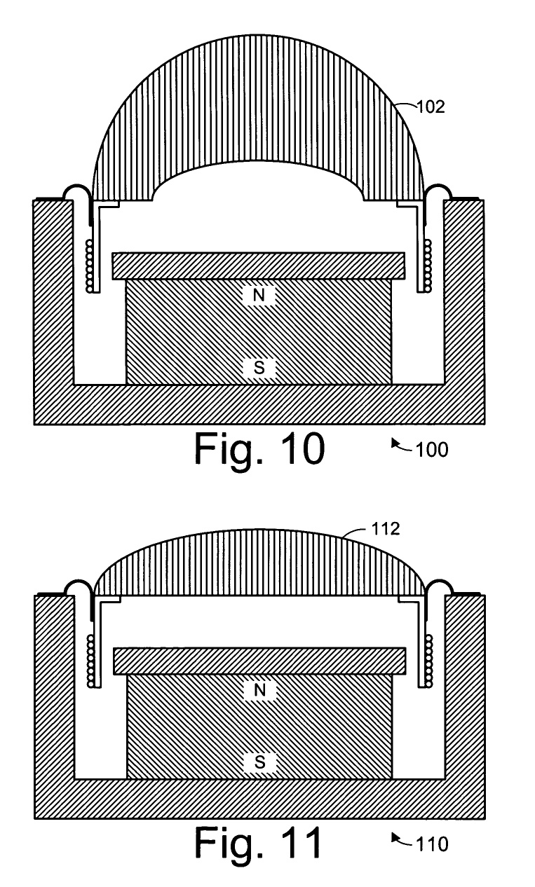

FIG. 10 illustrates another tweeter 100 utilizing a slightly different embodiment of an aerogel dome 102. The shape of the bottom surface of the dome does not necessarily have to be the same as the shape of the outer surface. The skilled engineer will, given the demands of a particular application and the teachings of this document, be able to make a suitable tradeoff between the amount of aerogel to remove from the underside of the dome, which may tend to reduce the overall structural stiffness of the dome, and the amount of air enclosed within the tweeter.

FIG. 11 illustrates another tweeter 110 utilizing an aerogel dome 112 which is a less than hemispherical section of a sphere. In some embodiments, the aerogel dome may not be a section of a sphere, but rather a section of some other shape such as an elliptical object like a football, in which case it will not have a circular footprint when viewed along the axis (that is, from the front of the tweeter, or from the top of the page as illustrated). In some such cases, the dome may have a hemispherical cross-section in one direction, and some other shape cross-section in another direction or plane.

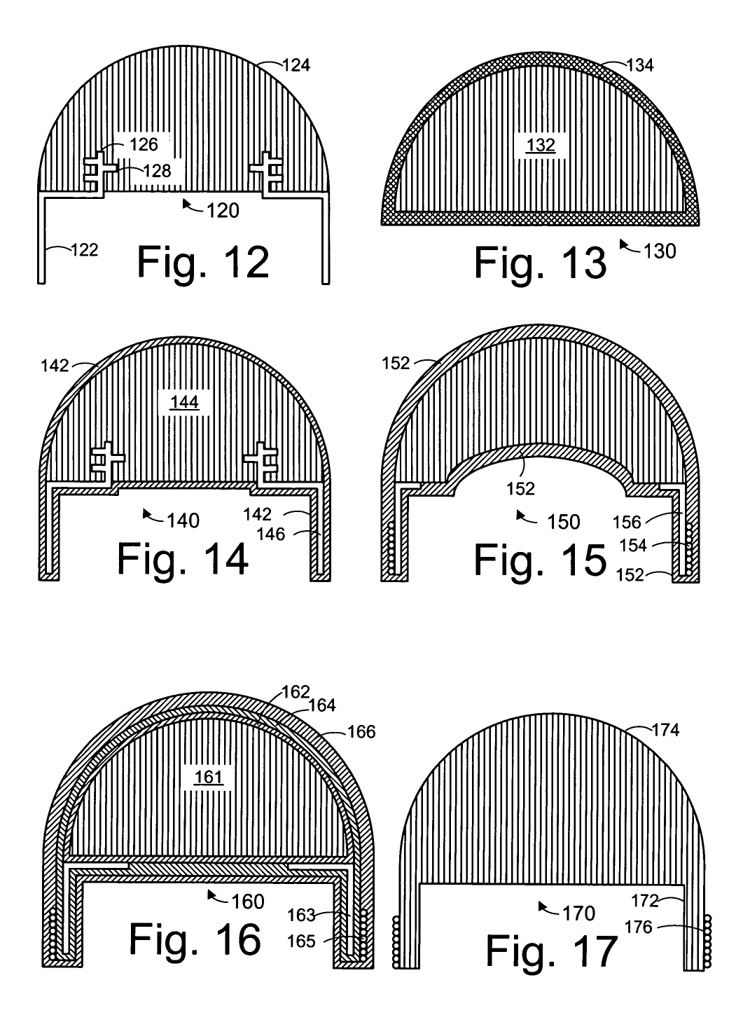

FIG. 12 illustrates one embodiment of a dome assembly 120 including a bobbin 122 which may advantageously be used with an aerogel dome 124. In order to improve mechanical coupling of the dome to the bobbin, the bobbin may include one or more structures 126 which penetrate inside the dome. Suitably, the dome may be manufactured e.g. by high temperature and pressure-critical point drying of a gel composed of colloidal silica structural units filled with solvents with the bobbin embedded inside the gel prior to drying. To further improve mechanical coupling, the penetrating structures 126 may include lateral extensions 128 which increase the surface area of bonding between the aerogel and the bobbin, and also provide direct mechanical coupling.

FIG. 13 illustrates further details of an aerogel dome 130 which may be employed in practicing this invention. In some cases, the naked aerogel structure 132 alone may not provide sufficient surface strength, in some measure due to the exposed ends of its microfibrous structures. In such cases, it is advantageous to provide the aerogel structure with an outer skin 134. In some embodiments, this outer skin may be formed by sputtering a suitable material onto the surface of the aerogel. Alternative methods, such as chemical vapor deposition, laminating, vacuum depositing, dipping, painting, or the like, may be used in some applications.

In some embodiments, the skin is formed of a material having high thermal conductivity, to improve cooling of the tweeter.

In some embodiments, the skin is formed of an elastic material such as plastic, to enable it to elastically damp any breakup modes that occur, however unlikely they may be, or to add additional strength (e.g. to help recover from a finger poking the dome in, as is so often seen in stereo shops).

The skin may be of any suitable thickness. In some embodiments, it may measure mere angstroms thick, such as if gold is sputtered onto the surface of the aerogel. In others, it may be significantly thicker. The thicker the skin, the greater strength it may offer, albeit at a mass penalty. However, this will not often be a meaningful issue, as the rigidity of the aerogel enables the skin to be minutely thick compared to the thin film or fabric domes of the prior art.

When faced with otherwise equally suitable choices of skin material, the designer may optionally opt for the one which is aesthetically preferred, such as gold or the like.

The skin may be formed of any suitable material, which the skilled designer will select according to the various demands of the application at hand, when armed with the teachings of this disclosure. Metallic skin materials may include, but are not limited to, titanium, beryllium, magnesium, scandium, aluminum, silver, gold, and alloys. Plastic skin materials may include, but are not limited to, polycarbonate, polyester (PET), polyethylene napthalate (PEN), polyimide, and fluoropolymer. Skins other than metals or plastics can be used, as well, such as various oxides of metals, of plastic, or of the aerogel itself.

In some embodiments, the skin may cover the entire aerogel dome structure, including its outer surface and its bottom surface, as shown. In other embodiments, only a portion of the aerogel structure is covered with the skin. In some such cases, it may be desirable to skin only the bottom surface, to improve its strength and its resistance to damage by the bobbin. In other such cases, it may be desirable to skin only the outer surface, to protect the aerogel from external impacts.

In some embodiments, more than one skin material may be utilized. For example, a laminated skin may be formed, by first painting a thin layer of plastic onto the aerogel, and then sputtering a layer of titanium nitride onto the plastic. In other embodiments, the underside may be skinned with a different material than the exterior surface. The skilled reader will appreciate a wide variety of possibilities, when enlightened with the teachings of this disclosure.

FIG. 14 illustrates another embodiment of a tweeter dome assembly 140, in which the skin 142 is formed not only over the aerogel structure 144, but over bobbin 146 as well. This may offer some degree of improvement in the coupling of the dome to the bobbin. In some cases, such as when the aerogel is formed with the bobbin in situ, it may be necessary or at least simpler to skin the whole assembly, rather than try to mask off some parts. However, in other embodiments, it may be desirable to skin only portions of the assembly.

FIG. 15 illustrates a similar embodiment of a tweeter dome assembly 150, with the additional feature of the skin 152 being applied over the dome assembly after the voice coil 154 has been wound around the bobbin 156. This may improve mechanical coupling of the voice coil to the bobbin, and may provide a smoother exterior surface of the bobbin/voice coil assembly to reduce frictional issues with ferrofluid coolant bathing the voice coil assembly.

FIG. 16 illustrates another embodiment of a tweeter dome assembly 160 with a more complex skin arrangement. The aerogel dome 161 is encapsulated in a first layer of skin 162. That assembly is coupled to the bobbin 163, then the resulting assembly is encapsulated in a second layer of skin 164. The voice coil 165 is wound around the resulting assembly, and then the entire structure is encapsulated in a third layer of skin 166. The layers may be of the same material, or of different materials, and may be applied in the same manner, or by different means.

FIG. 17 illustrates an aerogel dome 170 which is fabricated to include an integral bobbin 172 in a monolithic construction with the body 174 of the aerogel dome. The voice coil 176 is wound directly onto the bobbin-like extension 172 of the aerogel dome.

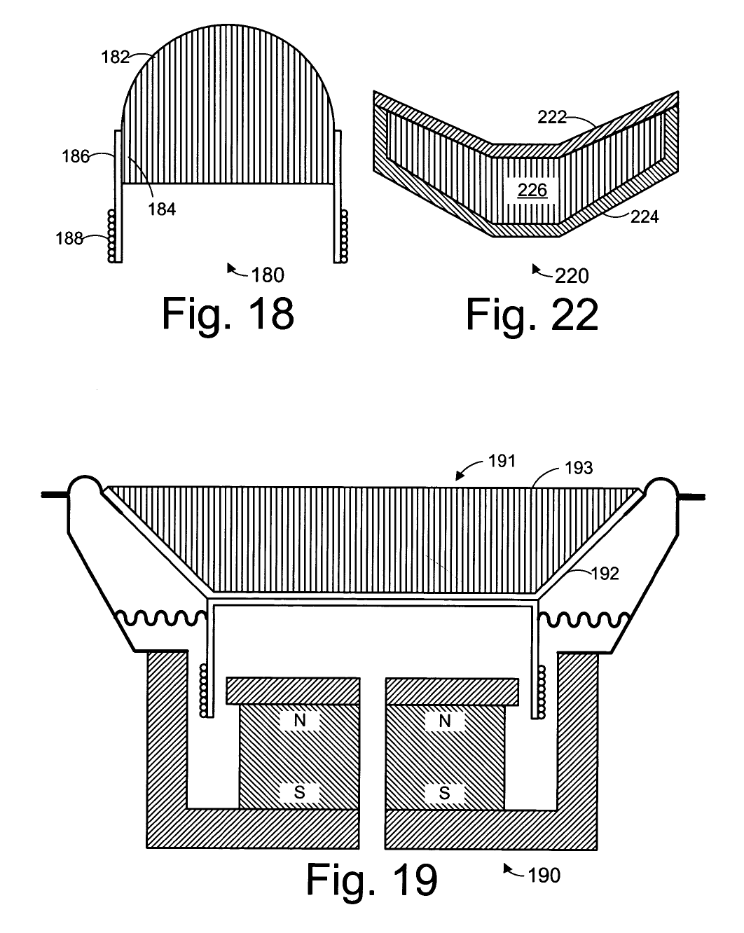

FIG. 18 illustrates an aerogel dome assembly 180 which includes a “silo” shaped aerogel dome having a hemispherical upper portion 182 and a cylindrical lower portion 184 for mating with a bobbin 186. The bobbin extends below the bottom of the aerogel dome to support a voice coil 188. The cylindrical sides of the lower portion of the aerogel dome fit inside and may be glued to the bobbin.

FIG. 19 illustrates a speaker 190 having a diaphragm 191 which includes an external shell 192 such as a polypropylene cone, which is filled with a solid filler body 193. The solid filler body is formed of an aerogel or other such material, such that the overall density of the diaphragm (the mass of the polypropylene cone plus the mass of the solid filler body, divided by the volume of the polypropylene cone plus the volume of the solid filler body) is less than 0.025 g/cm³ or less than 0.01 g/cm³. In some embodiments, the exterior surface of the solid filler body may be protected by a skin (not shown) of any suitable material.

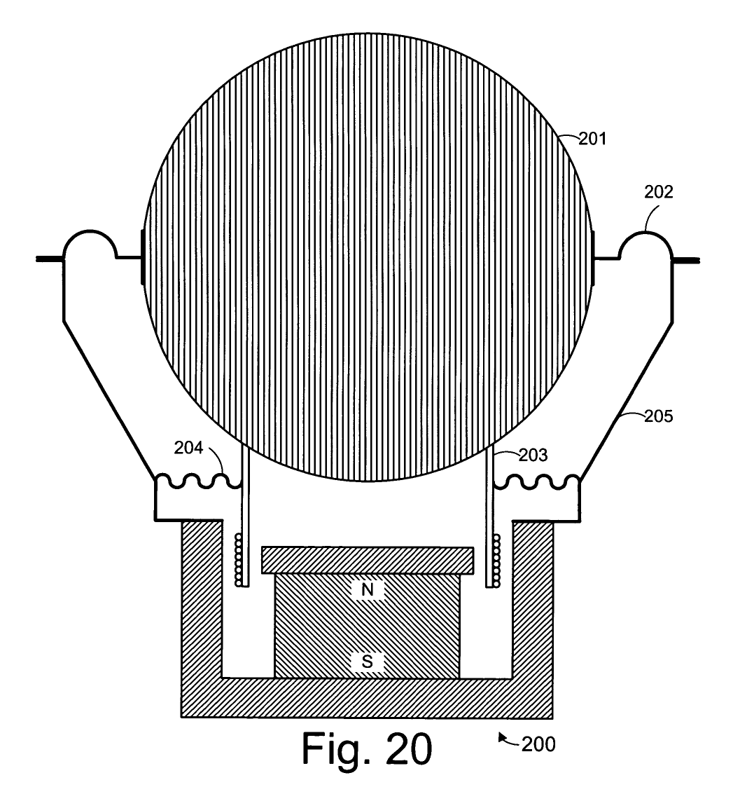

FIG. 20 illustrates another embodiment of a tweeter 200 utilizing a substantially spherical aerogel dome 201. With other materials, this would be an unacceptably massive structure, which the motor structure would be unable to adequately accelerate. However, due to the incredibly low mass density of aerogel, aerogel diaphragms may be made of almost arbitrarily large sizes and shapes. The spherical shape offers extremely high structural integrity.

A surround 202 may advantageously be coupled to the spherical aerogel dome at or near the “equator” of the sphere. The bobbin 203 may be coupled to (or inserted into) the spherical dome at any point, suitably a point dictated by the desired voice coil diameter of the motor structure. A spider 204 may be coupled to the bobbin. A frame 205 may be coupled to the motor structure to support the surround and the spider.

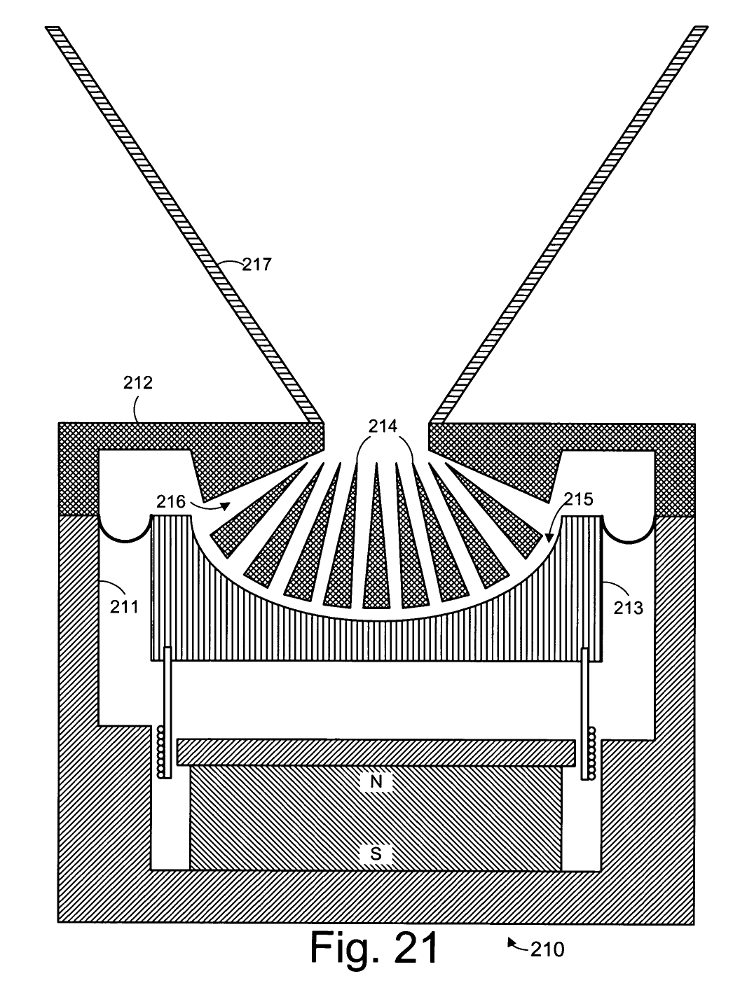

FIG. 21 illustrates a compression driver tweeter 210 which incorporates this invention. The compression driver includes a body 211, 212 which forms a substantially sealed motor chamber. The motor structure drives an inverted aerogel dome 213. The facing surfaces of the aerogel dome and a phase plug 214 ideally have a substantially similar shape, or, in other words, they have substantially mating dimensions. As the aerogel dome is driven toward the phase plug, the volume of air in the space 215 between the dome and the phase plug is compressed, and flows through channels 216 through the phase plug. Upon exiting the sealed motor chamber, the compressed air waves pass out through a horn 217 which increases the volume or area of air that is moved by the diaphragm, improving acoustic loading.

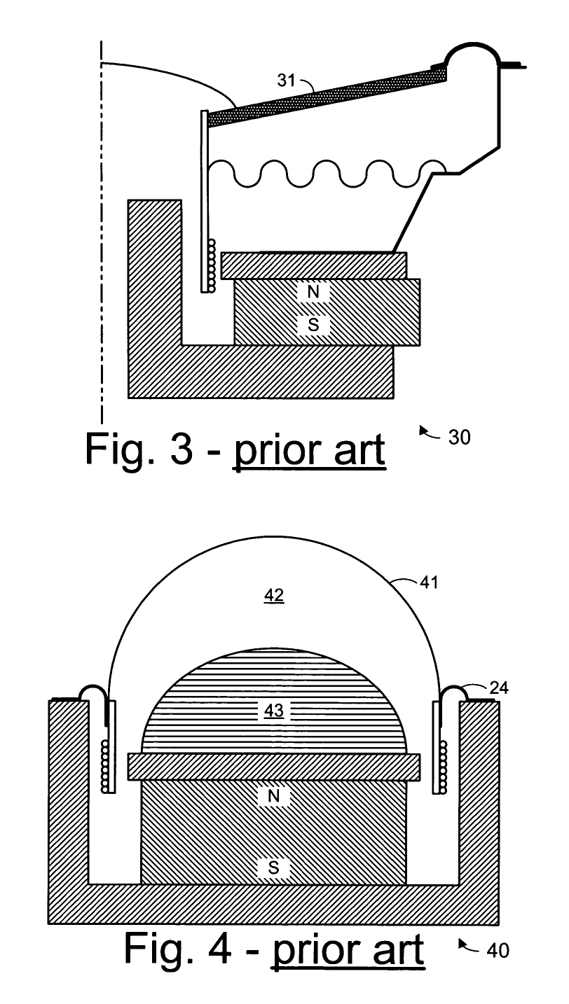

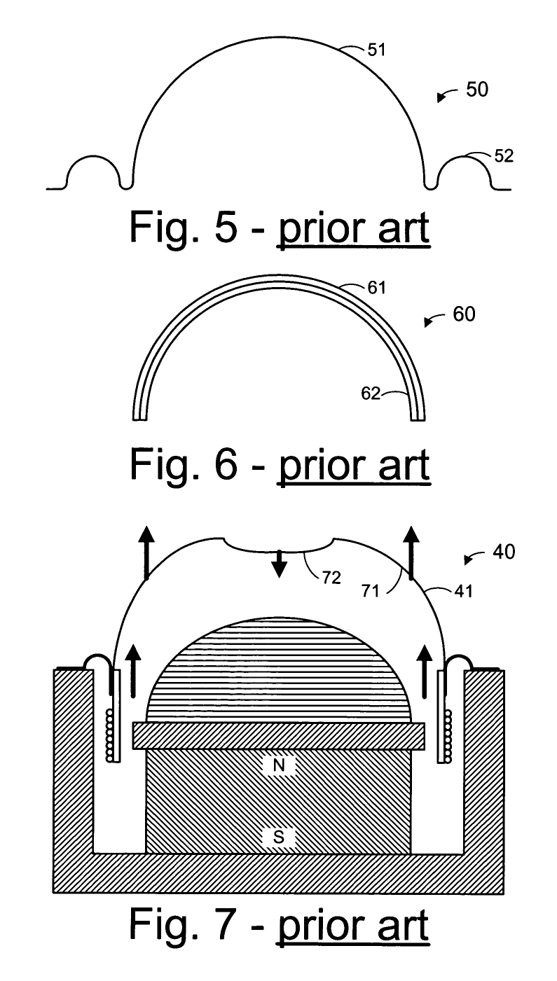

FIG. 3 may be understood to represent another embodiment of this invention, one not contemplated by the prior art, one in which nanoporous particles have been used as fill material intermixed with the e.g. polypropylene material of the cone. Even when mixed at the conventional 10% volumetric ratio, the use of nanoporous material will provide a significant density improvement over that of the talc etc. of the prior art. Additional improvements can be achieved by using a greater percentage of nanoporous filler, such as 15%, 20%, 25%, 50%, 75%, or more by volume. In some applications, the volume of the nanoporous particles may be less than 1 cubic millimeter each, and there may be 1,000 or more such particles in each diaphragm. In some applications, the nanoporous particles may be vastly smaller and their numbers vastly greater, as per the needs of the application at hand.

One especially advantageous plastic which may be used in practicing this invention is polymethylpentene, such as that available from Westlake Plastics Company, P.O. Box 127, Lenni, Pa. 19052, under the trademark TPX®. TPX is a polyolefine which has the lowest specific gravity (density) of any available thermoplastic, 0.833. TPX also has an excellent strength to weight ratio, low water absorption, high melting temperature, and excellent acoustic properties such as a low speed of sound propagation. Its has only recently come into use in a very few audio speaker diaphragms, and in those it is used without filler material.

One especially useful characteristic of TPX is that it is translucent, and nearly transparent, with only a slight amber tint. Aerogel is also nearly transparent. TPX filled with aerogel particles offers all of the advantages of filled plastic diaphragms identified above, plus the additional advantage that the filled plastic remains UV transparent, enabling the manufacturer to use UV-cured adhesives to e.g. bond the diaphragm to the bobbin, bond the spider to the bobbin, and so forth, from the readily-accessible front side of the speaker, curing the adhesives right through the diaphragm.

Many purchasers appreciate the aesthetic appearance of a transparent diaphragm, which makes the underlying spider, bobbin, voice coil, and other components visible. This aesthetic appearance can be achieved either with the raw, nearly colorless TPX and aerogel, or in combination with a color tint. In one embodiment, the color tint is added to the TPX. In another embodiment, the color tint may be added to the aerogel particles. For example, some or all of the aerogel particles, granules, or beads may be dyed. Alternatively, they may be coated with an extremely thin layer of plastic or metal, such as by vapor deposition of an extremely thin layer of gold, giving the diaphragm a transparent and yet shiny, metallic color. Alternatively, the metallic particles could be added directly to the TPX.

FIG. 22 illustrates a diaphragm 220 according to another embodiment of this invention. The diaphragm is a sandwiched cone (or other suitable shape) in which an upper layer 222 and a lower layer 224 of polypropylene or other suitable material surround and encapsulate a volume of nanoporous material 226. The nanoporous material may be a monolithic, rigid block or sheet, or it may be comprised of a large number of small particles such as beads.

### Conclusion

In the several embodiments shown above, various modifications, combinations, and changes may be made within the scope of this invention.

In some embodiments, the diaphragm may have an internal mass density (of its aerogel etc. filler, not counting its skin) in the range 0.0013-0.009 g/cm³. In other embodiments, it may have an internal mass density in the range 0.0013-0.005 g/cm³. By way of contrast, polystyrene foam has a density of approximately 0.01 g/cm³.

In some embodiments, the diaphragm may have an overall mass density (including any skin and any supporting cone) in the range 0.002-0.02 g/cm³. In other embodiments, it may have an overall mass density in the range 0.002-0.015 g/cm³. By way of contrast, alloy skinned polystyrene foam has a density of approximately 0.027 g/cm³.

In some embodiments, nanoporous material makes up more than 50% of the overall diaphragm by volume. In other embodiments, nanoporous material makes up more than 75% of the overall diaphragm, by volume. In other embodiments, more than 90%. In other embodiments, more than 95%. And in some other embodiments, more than 99% of the overall diaphragm is nanoporous material, by volume.

When one component is said to be “adjacent” another component, it should not be interpreted to mean that there is absolutely nothing between the two components, only that they are in the order indicated. The various features illustrated in the figures may be combined in many ways, and should not be interpreted as though limited to the specific embodiments in which they were explained and shown. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element. Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

1. An electromagnetic transducer comprising:
a motor structure including a magnetic air gap;
a voice coil disposed within the magnetic air gap; and
a diaphragm coupled to the voice coil, wherein the diaphragm has an overall mass density lower than 0.01 g/cm³.

2. The electromagnetic transducer of claim 1 wherein the diaphragm has an overall mass density lower than 0.005 g/cm³.

3. The electromagnetic transducer of claim 1 wherein the diaphragm comprises a nanoporous material.

4. The electromagnetic transducer of claim 3 wherein the nanoporous material comprises at least one of aerogel, solgel, and nanocomposite material.

5. The electromagnetic transducer of claim 3 wherein the diaphragm further comprises a skin.

6. The electromagnetic transducer of claim 5 wherein the skin encapsulates the entire diaphragm.

7. The electromagnetic transducer of claim 5 wherein the skin comprises at least one of a sputtered layer, a chemical vapor deposition layer, and a vacuum deposited layer.

8. The electromagnetic transducer of claim 5 wherein the skin comprises at least one of metal, plastic, and oxide.

9. The electromagnetic transducer of claim 1 wherein the diaphragm comprises one of a sphere, a hemisphere, a less than hemispherical section of a sphere, a silo shape, and a filled cone shape.

10. The electromagnetic transducer of claim 1 further comprising:
a bobbin coupled to the diaphragm and to the voice coil.

11. The electromagnetic transducer of claim 10 further comprising a skin encapsulating the diaphragm.

12. The electromagnetic transducer of claim 11 wherein the skin further encapsulates the bobbin.

13. The electromagnetic transducer of claim 12 wherein the skin further encapsulates the voice coil.

14. The electromagnetic transducer of claim 10 wherein the bobbin comprises an integral part of the diaphragm and is constructed of aerogel.

15. The electromagnetic transducer of claim 1 configured as an audio tweeter and wherein the diaphragm comprises a dome shape.

16. The electromagnetic transducer of claim 1 configured as a compression driver.

17. The electromagnetic transducer of claim 1 configured as a microphone.

18. An electromagnetic transducer comprising:
a motor structure;
a suspension component coupled to the motor structure; and
a diaphragm coupled to the suspension component, wherein the diaphragm comprises more than 50% by volume a nanoporous material.

19. The electromagnetic transducer of claim 18 wherein:
the diaphragm comprises more than 75% by volume a nanoporous material.

20. The electromagnetic transducer of claim 19 wherein:
the diaphragm comprises more than 90% by volume a nanoporous material.

21. The electromagnetic transducer of claim 20 wherein:
the diaphragm comprises more than 95% by volume a nanoporous material.

22. The electromagnetic transducer of claim 21 wherein:
the diaphragm comprises more than 99% by volume a nanoporous material.

23. The electromagnetic transducer of claim 18 wherein:
the nanoporous material comprises aerogel.

24. A tweeter audio speaker comprising:
a motor structure having a magnetic air gap;
a diaphragm including a substantially solid dome of nanoporous material; and
a voice coil coupled to the diaphragm and disposed within the magnetic air gap.

25. The tweeter audio speaker of claim 24 further comprising a skin coupled to the dome.

26. The tweeter audio speaker of claim 25 further comprising a bobbin coupling the dome to the voice coil.

27. The tweeter audio speaker of claim 26 wherein the skin is further coupled to the bobbin.

28. The tweeter audio speaker of claim 27 wherein the skin is further coupled to and overlies the voice coil.

29. The tweeter audio speaker of claim 28 wherein the skin comprises at least two layers of skin.

30. The tweeter audio speaker of claim 26 wherein the bobbin comprises nanoporous material and is monolithic with the dome.

31. The tweeter audio speaker of claim 24 wherein the skin comprises at least one of metal, plastic, and oxide.

32. The tweeter audio speaker of claim 31 wherein the skin is formed on the dome by at least one of sputtering, chemical vapor deposition, vacuum deposition, laminating, dipping, and painting.

33. The tweeter audio speaker of claim 24 wherein the dome has a shape comprising one of spherical, hemispherical, sub-hemispherical, silo-shaped, and filled cone.

34. The tweeter audio speaker of claim 24 wherein the nanoporous material comprises at least one of aerogel, solgel, and nanocomposite material.

35. An audio speaker comprising:
a motor structure having a magnetic air gap;
a diaphragm including a plastic and a nanoporous material distributed within the plastic so as to be substantially encapsulated by the plastic; and
a voice coil coupled to the diaphragm and disposed within the magnetic air gap.

36. The audio speaker of claim 35 wherein the diaphragm comprises at least 10% nanoporous material by volume.

37. The audio speaker of claim 36 wherein the diaphragm comprises at least 25% nanoporous material by volume.

38. The audio speaker of claim 37 wherein the diaphragm comprises at least 50% nanoporous material by volume.

39. The audio speaker of claim 35 wherein the diaphragm comprises a plurality of particles of nanoporous material.

40. The audio speaker of claim 39 wherein the nanoporous material comprises more than 1,000 particles of nanoporous material each less than 1 cubic millimeter in volume.

41. The audio speaker of claim 35 wherein the nanoporous material comprises a sheet, and the plastic comprises a plurality of layers sandwiching the sheet of nanoporous material.

42. The audio speaker of claim 35 wherein the plastic comprises polypropylene.

43. The audio speaker of claim 42 wherein the nanoporous material comprises aerogel.

44. The audio speaker of claim 35 wherein the nanoporous material comprises a sheet, and the plastic comprises a plurality of layers sandwiching the sheet of nanoporous material.

45. An improvement in an audio speaker, the audio speaker comprising,
a motor structure including a magnetic air gap; and
a diaphragm assembly including,
a bobbin,
a voice coil coupled to the bobbin and disposed within the magnetic air gap,
a suspension component coupling the diaphragm assembly to the motor structure, and
a diaphragm coupled to the bobbin;
wherein the improvement comprises the diaphragm being comprised of a substantially translucent plastic filled with particles of a substantially translucent nanoporous material.

46. The improvement in the audio speaker of claim 45, wherein the improvement further comprises the substantially translucent plastic comprising polymethylpentene.

47. The improvement in the audio speaker of claim 46, wherein the improvement further comprises the substantially translucent nanoporous material comprising aerogel.

48. The improvement in the audio speaker of claim 47, wherein the improvement further comprises at least some of the particles having a tint added to them.

49. The improvement in the audio speaker of claim 48, wherein the improvement further comprises the tint comprising a vapor deposited layer of metal.
